(19) United States
(12) Patent Application Publication
(10) Pub. No.: US 2014/0151158 A1
(43) Pub. Date: Jun. 5, 2014

(54) ARRANGEMENT FOR A CAPTURE DEVICE INTENDED TO BE USED IN SURROUNDING IN WHICH THERE IS A RISK OF EXPLOSION

(71) Applicant: Mats Olsson, Skelleftea (SE)

(72) Inventor: Mats Olsson, Skelleftea (SE)

(73) Assignee: Alimak Hek AB, Skellefteå (SE)

(21) Appl. No.: 14/130,270

(22) PCT Filed: Jun. 19, 2012
(86) PCT No.: PCT/SE2012/050676

§ 371 Date: Feb. 13, 2014

(30) Foreign Application Priority Data
Jul. 1, 2011 (SE) 1150617-7

(51) Int. Cl. B66B 5/18

(52) U.S. Cl. CPC B66B 5/18
USPC 187/352

(57) ABSTRACT

The invention concerns an arrangement for a capture device (1a) for a lift. A capture device has a brake housing (1c) that surrounds a centrifugal regulator with an axle (2) that rotates with the lift car, a brake with a fixed brake part (6) and a displaceable brake part (8), a spring (16), on activation the axle (2) is coupled to the rotatable brake part (8) in order to compel it to rotate, and to a tension arrangement (22) for the spring (16) arranged to press the displaceable brake part against the fixed brake part. In order to achieve utility in surroundings in which there is a risk of explosion, the brake housing (1c) is designed as an explosion-proof detonation chamber, outwardly limited by a cylinder, the inner surface of which forms the fixed brake part (6), an end plate (1d) and an end plate (28), whereby the brake housing (1c) has a flame pathway (50:1-50:n) designed as a channel that has been given an area for heat exchange that has been so selected that exhaust gases from an explosion in the brake housing deposit sufficient heat during passage through the flame pathway that the exhaust gases that emanate from the brake housing through the flame pathway are sufficiently cooled that they do not risk igniting the surroundings.

The present invention concerns an arrangement for a capture device for a lift, preferably a lift driven by a cogged rod, intended to be used in surroundings and environments in which there is a risk of explosion, and that contain explosive concentrations of flammable gases, dust or fumes. Such lifts are, for example, lifts that are used for the transport of personnel and goods on oil platforms or during underground mining.

Special requirements are placed on lifts that are used in surroundings and environments in which there is a risk of explosion and that contain explosive concentrations of flammable gases, dust or fumes. In order to aid understanding, it can be mentioned that the presence of three conditions must be satisfied in order for fire to arise, namely fuel, oxygen and heat. Even dust in the form of small particles mixed with air is highly flammable and can give rise to explosive fires. In contrast to lifts of line or wire type, lifts that are driven by cogged rods often have special areas of application for the transport of personnel and goods in such demanding environments.

A lift that is driven by a cogged rod comprises a vertical cogged rod and has a lift car that, running along a vertical mast, supports drive machinery that has a drive wheel on an axle, which drive wheel is in interaction with the cogged rod, in order to drive the lift car upwards or downwards, depending on the selected direction of rotation, along the mast and the cogged rod that extends along the mast. The lift car is supported also by a capture device with a centrifugal regulator that has on its axle a cogged wheel that interacts with the cogged rod in a manner that transfers motion. The centrifugal regulator is arranged such that it applies a drum brake inside a common regulator and brake housing when a predetermined rate of revolution is exceeded, whereby the brake is arranged for gradual braking of the regulator axle and thus stationary braking of the lift car relative to the cogged rod. In particular in the case of large lift cars with a large loading capacity and high weight, the brake of the capture device is subject to extremely high load when it is activated since the braking effect will be many times higher than it is for corresponding smaller lift cars. Enormous amounts of energy are released in the form of heat when the capture device is activated. When a capture device is activated, very high temperatures and the formation of sparks may appear, in particular at the outer circumference of the brake drum. In the cases in which the lift is used in surroundings in which there is a risk of explosion, there is a risk that an internal spark or flame that is formed inside the capture device spreads from the interior of the capture device into the explosive environment that surrounds the capture device.

It would therefore be desirable to achieve a capture device that can be used in surroundings and environments in which there is a risk of explosion and that contain explosive concentrations of flammable gases, dust. Such a capture device must, of course, withstand an internal explosion of flammable gas or fumes that penetrates the interior of the capture device, without being damaged and without the internal formation of flame or sparks that are formed coming into connection with the explosive environment that surrounds the lift. The machine housing of the capture device must, furthermore, be so completely sealed that dirt, particles and dust cannot penetrate it and influence the function of the mechanical components inside the capture device.

One purpose of the present invention, therefore, is to achieve a capture device for a lift, in particular a lift driven by a cogged rod, intended to be used in surroundings and environments in which there is a risk of explosion and that contain explosive concentrations of flammable gases, dust or fumes. A second purpose of the invention is to achieve an arrangement that is easy to mount onto an existing capture device of conventional type and that results in the capture device corresponding to the standards for use in explosive surroundings.

As a part of this, the use of an arrangement that uses traditional mechanical parts is aspired to, and one that is easy to mount also at a capture device for the upgrading of the capture device in order to allow existing lifts to be used in explosive environments, which capture device in a convincing manner corresponds to and satisfies the standards for function and operation in an explosive atmosphere.

This purpose is achieved through a capture device that has been given the characteristics and distinctive features that are specified in claim 1. Further advantages of the invention are made clear by the non-independent claims. The insight that forms the basis of the invention is to design the capture device as an “open enclosed capture device”, i.e. a capture device that has been dimensioned to resist the sudden increase in pressure from an internal explosion at the same time as the capture device allows gases from an explosion to emanate from the interior of the capture device in a controlled manner at the same time as the gases are cooled on their way out.

Due to the invention, an “open enclosed capture device” is offered, i.e. a capture device that has been dimensioned to resist the sudden increase in pressure from an internal explosion and to allow hot gases from an explosion to emanate from the interior of the capture device in a controlled manner at the same time as the gases are cooled on their way out. For this cooling effect, the channels of the capture device according to the invention are designed as flame pathways, in the form of, for example, gaps that are formed between adjacent machine parts in the brake housing. Each flame pathway is designed with a length and a width that are so adapted that hot gases that are formed in an explosion are cooled during their passage, and there is sufficient time for them to deposit sufficient heat to the machine housing during their passage through the pathway that the emanating gases demonstrate a sufficiently low temperature that they do not risk igniting the surroundings. An explosion concerns a process that releases energy so rapidly that it gives rise to a pressure wave through the rapid expansion of the gases. In accordance with the invention, focus has been placed on the fact that it is sufficient that the third of the three preconditions that are required for it to be possible for fire to arise is avoided: namely; the presence of a flammable substance, for example wood dust or petrol; the presence of an oxidising agent, for example oxygen gas (air); that the temperature is elevated as a consequence of a process or an external source of heat to above the point at which a self-maintained oxidation that is not controlled by temperature arises.

The invention will be described below in more detail with reference to the attached drawings, of which:

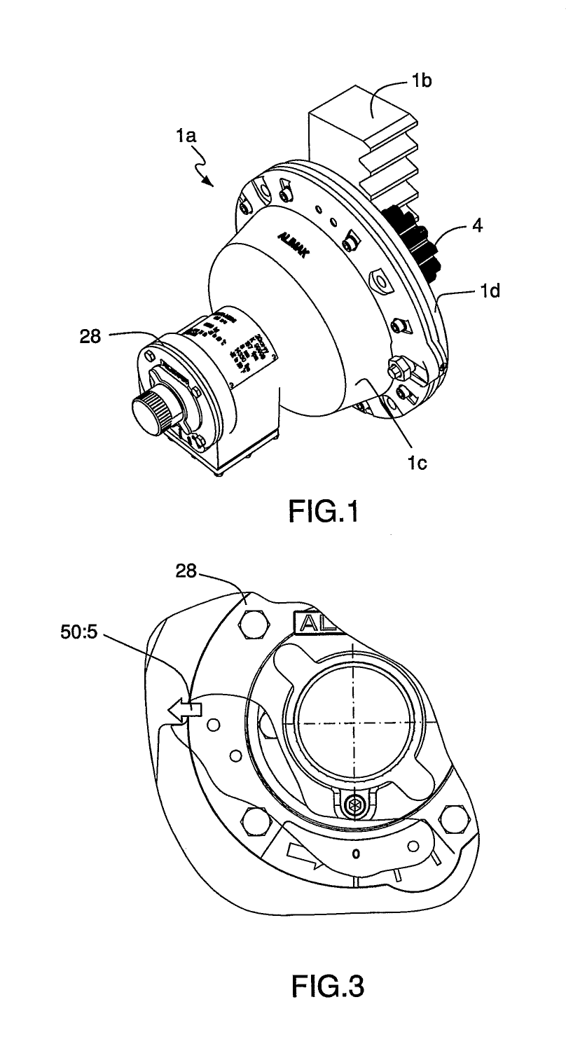

FIG. 1 shows a perspective view of a capture device according to the invention that is in interaction with a cogged rod through a cogged wheel that is arranged at the capture device,

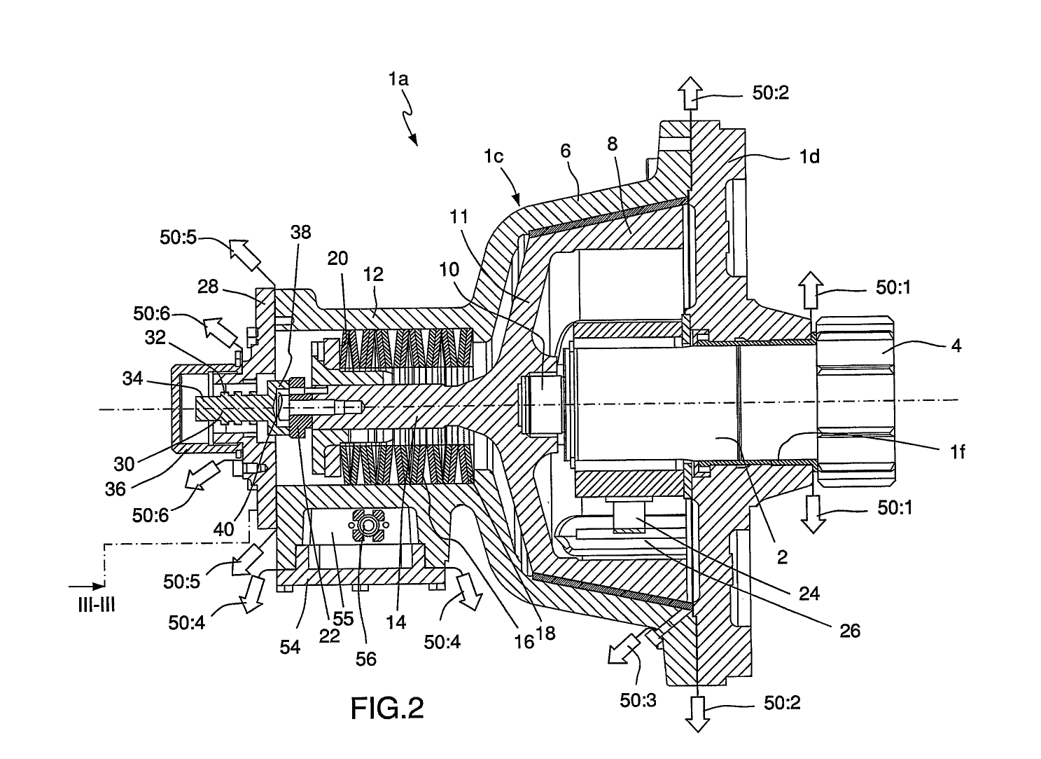

FIG. 2 shows an axial sectional view of a capture device according to the first embodiment of the invention, and

FIG. 3 shows a partial cross-sectional view of a part of a capture device according to the invention viewed along the line III-III in FIG. 2.

The capture device 1a shown in FIG. 1 is intended to be a component of a lift that is driven by a cogged rod, i.e. a lift of the type that comprises a vertical cogged rod 1b and that has a lift car (not shown in the drawings) that, running along a vertical mast (not shown in the drawings), supports drive machinery that has on an axle a drive wheel that interacts with the cogged rod. The lift car is driven upwards or downwards, depending on the direction of rotation that is chosen, along the mast and the cogged rod that extends along the mast. The capture device 1a has, according to the invention, been given what is known as an “open enclosure”, demonstrating an explosion-proof brake housing 1c that has been constructed and dimensioned such that it forms a detonation chamber, and that can resist without collapsing a sudden increase in pressure from an explosion inside the brake housing. The open enclosure also ensures that hot combustion gases that arise in the explosion, hereafter denoted by “exhaust gases”, are limited in a controlled manner from propagating to the surroundings, whereby the hot exhaust gases are allowed to reach the surrounding atmosphere only after the required cooling has taken place, during which cooling the exhaust gases have reached a sufficiently low temperature that they do not risk igniting explosive gases in the surroundings. The adjacent machine parts that form the brake housing 1c are manufactured from sheet steel whereby, during the selection of suitable dimensions, consideration has been taken of the loads during the occurrence of an internal explosion during the formation of a “detonation chamber” and how an internal excess pressure of hot gases that has developed in this manner is influenced while being led out through channels arranged in the brake housing and designed as flame pathways or gaps. In order to maintain the dimensions small, it is appropriate to use the tensile strength of high-quality steel during the manufacture of the various machine parts that are components of the capture device 1a.

As is made clear by FIG. 2, the capture device 1a is shown in more detail, and in its constructive execution has a stationary brake housing 1c that is outwardly limited by a horizontal hollow cylinder of sheet steel with a diameter that reduces in steps and that is provided at its broader end with an end plate 1d that is manufactured from sheet steel and that extends essentially radially. The brake housing is provided at its more narrow end with an end plate 28 that has a relatively small diameter. A centrifugal regulator is housed within the brake housing 1c of the capture device, which centrifugal regulator demonstrates, on an axle 2 that can be rotated and that extends through a central opening 1f in the said end plate 1d, at its free end a cogged wheel 4 that interacts with the cogged rod 1b. The centrifugal regulator is arranged in a slightly conical drum brake with a fixed brake part 6, and a displaceable brake part 8 that can be rotated and displaced towards and away from the fixed brake part. To be more precise, the end 10 of the axle of the centrifugal regulator that faces away from the cogged wheel 4 is mounted in bearings in a manner that allows rotation in the centre of an end wall 11 at the rotatable brake part 8. The fixed brake part 6 forms part of the brake housing 1c, another part 12 of which encloses an axle journal 14, which is fixed attached to the rotatable end wall 11 of the brake 8, coaxially with its axis of rotation. The latter housing part 12 thus encloses a spring washer package 16 that surrounds the axle journal 14 and acts between a contact 18 of the housing at the inner end of the axle journal and a contact 20 close to the free end of the axle journal. The latter contact is supported by a sheath 22 that is in threaded interaction with the axle journal 14. On activation, one or several of the suggested centrifugal bodies 24 on the regulator axle 2 are caused to interact with a contact 26 on the inner surface of the rotatable brake part 8. In this way, this is caused to accompany the rotation of the regulator axle 2, which results in the sheath 22 that accompanies the rotation being caused to be displaced along the axle journal in a direction that leads to a reduction in the distance between the contacts 18 and 20. The spring washer package 16 is in this way gradually placed under tension and the rotatable brake part 8 is pressed ever harder against the fixed brake part 6.

The housing part 12 is terminated at the end of the said end plate 28, through which a screw 30 with a large pitch extends, as is suggested at 32. The screw 30 outside of the end plate has a head 34 designed for interaction with a suitable tool, such as a U-wrench. The head 34 is located under an end cover 36 that can be removed. The second end of the screw 30 is expanded, as is suggested at 38, and makes contact with a ring-shaped end surface 40 against the end of the axle journal 14.

According to the invention, the interior of the brake housing 1 forms a “detonation chamber” that is dimensioned to withstand the loads from the internal increase in pressure that arises during an explosion. The capture device and in particular the various machine parts that together form the brake housing of the capture device have been assigned channels, which, in the execution of the invention described here, are designed as a number of flame pathways 50:1-50:n and ensure that hot gases that are formed in the explosion can be led in a controlled manner from the interior of the brake housing 1c and—well-cooled—onwards out to the surrounding atmosphere. Each such channel or flame pathway 50:1-50:n has been given a predetermined length and width, i.e. a heat-transfer area, that has been so adapted that hot gases that are formed in the explosion are cooled during passage through the said flame pathway or series of flame pathways, by depositing sufficient heat to the machine housing that exhaust gases from the explosion that are emitted from each flame pathway demonstrate a sufficiently low temperature that they do not risk igniting the surroundings. Each flame pathway 50:1-50:n is designed as a gas-transfer channel or gap between the adjacent machine parts of the capture device that together limit the interior compartment of the brake housing 1 with respect to the surrounding atmosphere.

As is made clear by FIG. 2, a first flame pathway 50:1 is located at the interface between the central opening 1f of the end plate 1d and the axle 2, a second flame pathway 50:2 is located at a radially extended flange coupling between the brake housing 1c and the end plate 1d, a third flame pathway 50:3 is located at the interface between a screw 51 and a threaded drilled hole 52 in the jacket of the brake housing 1, a fourth flame pathway 50:4 is located at the interface between a cover 54 and an internal sub-compartment 55 of a travel limit switch 56 arranged at brake housing 1c, a fifth flame pathway 50:5 is located at the interface between a flange coupling between the end plate 28 and the brake housing 1c, and a sixth flame pathway 50:6 is located at the interface between an end cover 36 and the said end plate 28, see also FIG. 3.

Due to the “open enclosure” of the capture device, with an explosion-proof brake housing that is designed and dimensioned to form a detonation chamber, in combination with flame pathways that, arranged in the brake housing, allow exhaust gases from an explosion in the chamber to be led away in a controlled manner while being cooled, a capture device is obtained that is simple and cheap to manufacture and that satisfies the requirements that are placed from the point of view of safety on lifts that are intended to be used in an explosive environment. The flame pathways 50:1-50:n in the brake housing 1c demonstrate forms and dimensions with respect to length and area that allow a sufficiently efficient exchange of heat that the exhaust gases that are generated in an explosion in the brake housing deposit sufficient heat during their passage through the said flame pathway that the exhaust gases are sufficiently cooled and demonstrate a sufficiently low temperature when they emanate from the brake housing that they do not risk igniting the surroundings.

The invention is not limited to that which has been described above and shown in the drawings: it can be changed and modified in several different ways within the scope of the innovative concept defined by the attached patent claims.

1. An arrangement for a capture device for a lift driven by a cogged rod for use in surroundings in which there is a risk of explosion, where the capture device comprises:
a shell-shaped brake housing that surrounds a centrifugal regulator that is of the type that has an axle that, extending out of the housing, rotates due to a coupling with the motion of the lift car,
a brake with a fixed brake part and a displaceable brake part that interacts with it, which displaceable brake part can be rotated and displaced towards and away from the fixed brake part, and which in a normal condition is free of the said axle,
a spring by which the displaceable brake part is forced in the direction towards the fixed brake part, whereby the centrifugal regulator is arranged such that on activation it couples the said axle to the rotatable brake part in order to compel this to rotate, and to a tension arrangement for the spring, which is arranged to interact with the spring as a consequence of the rotation of the regulator such that the spring presses the displaceable brake part gradually harder against the fixed brake part,
wherein the brake housing is designed as an explosion-proof detonation chamber that is outwardly limited by a horizontal hollow cylinder, the inner surface of which forms at the same time the fixed brake part of the capture device and which cylinder is limited at its ends by an end plate and an end plate, whereby the brake housing has been assigned at least one flame pathway designed as a channel, where each flame pathway has been given an area for heat exchange that has been so selected that exhaust gases generated in an explosion in the brake housing deposit sufficient heat during passage through the flame pathway that the exhaust gases that emanate from the brake housing through the flame pathway are sufficiently cooled that they do not risk igniting the surroundings.

2. The arrangement according to claim 1, whereby each flame pathway is designed as a gas-transfer gap between the adjacent machine parts of the capture device that together limit the interior compartment of the brake housing with respect to the surrounding atmosphere.

3. The arrangement according to claim 2, whereby a gas-transfer gap for a first flame pathway is located at the interface between the axle and a central opening in the first end plate through which the axle extends.

4. The arrangement according to claim 2, whereby a gas-transfer gap for a second flame pathway is located at a radially extended flange coupling between the brake housing and the first end plate.

5. The arrangement according to claim 2, whereby a gas-transfer gap for a third flame pathway is located at the interface between a screw in the brake housing and a threaded drilled hole in the jacket of the brake housing.

6. The arrangement according to claim 2, whereby a gas-transfer gap for a fourth flame pathway is located at the interface between a cover in the brake housing and a travel limit switch arranged in an internal sub-compartment of the brake housing.

7. The arrangement according to claim 2, whereby a gas-transfer gap for a fifth flame pathway is located at the interface between a flange coupling between the end plate and the brake housing.

8. The arrangement according to claim 2, whereby a gas-transfer gap for a sixth flame pathway is located at the interface between an end cover in the brake housing and the end plate.
